(19) United States
(12) Patent Application Publication
(10) Pub. No.: US 2020/0099099 A1
(43) Pub. Date: Mar. 26, 2020

(54) NON-AQUEOUS ELECTROLYTES FOR HIGH VOLTAGES BATTERIES EMPLOYING LITHIUM METAL ANODES

(71) Applicant: UChicago Argonne, LLC, Chicago, IL (US)

(72) Inventors: Khalil Amine, Oakbrook, IL (US); Chi Cheung Su, Westmont, IL (US); Meinan He, Willowbrook, IL (US); Zonghai Chen, Bolingbrook, IL (US)

(21) Appl. No.: 16/137,037

(22) Filed: Sep. 20, 2018

(51) Int. Cl. H01M 10/0567; H01M 10/42; H01M 10/0568; H01M 4/38; H01M 10/0569; H01M 10/0565; H01M 10/052

(52) U.S. Cl. CPC H01M 10/0567; H01M 10/4235; H01M 10/0568; H01M 4/382; H01M 2004/027; H01M 10/0565; H01M 10/052; H01M 2300/0088; H01M 2300/0025; H01M 10/0569

(57) ABSTRACT

An electrochemical cell includes a cathode comprising a cathode active material; an anode comprising lithium metal (Li⁰); a separator; and an electrolyte comprising a lithium salt, an organic aprotic solvent, and a difluoroethylene carbonate which is:

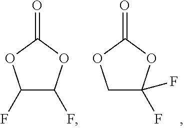

or a mixture of any two or more thereof.

### GOVERNMENT RIGHTS

This invention was made with government support under Contract No. DE-ACO2-06CH11357 awarded by the United States Department of Energy to UChicago Argonne, LLC, operator of Argonne National Laboratory. The government has certain rights in the invention.

### FIELD

The present technology is generally related to lithium rechargeable batteries. More particularly the technology relates to the use of difluoroethylene cabonates in an electrochemical cell having a metallic lithium anode.

### BACKGROUND

Lithium-ion batteries are used extensively as electrical power for portable electronics and hybrid electric vehicles. To facilitate the application of pure electric vehicles, lithium-ion batteries having high energy density are essential to the effort. To increase the energy density of the batteries, new anode and cathode materials are actively pursued. However, the battery performance fades rapidly at increasing potential due to the parasitic reaction of the state-of-the-art electrolytes on the cathode surface, causing transition metal ion dissolution into the electrolyte solution.

Because of its ultra-high capacity (3860 mAhg⁻¹), low atomic weight (6.94 gml⁻¹) and negative electrochemical potential (−3.04V vs. the standard hydrogen electrode), lithium metal is an ideal anode material for rechargeable batteries. However, its extensive application has been hindered by severe safety issues associated with lithium dendrite formation and unsatisfactory Coulombic efficiency during battery cycling. It is believed that electrolyte selection is critical in stabilizing the lithium plating/stripping process. Conventional lithium-ion battery electrolytes cannot effectively suppress the lithium dendrite formation. Moreover, the oxidation instability of regular carbonate solvent impeded its application in high voltage battery.

It is therefore of great interest to the battery industry to identify electrolyte systems that enable stable lithium metal anode cycling, possess excellent solid-electrolyte interphase (SEI) forming ability, and that have high oxidation stability.

### SUMMARY

In one aspect, an electrochemical cell includes a cathode comprising a cathode active material; an anode comprising lithium metal (Li⁰); a separator; and an electrolyte comprising a lithium salt, an organic aprotic solvent, and a difluoroethylene carbonate which is:

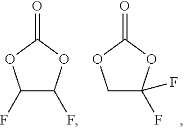

or a mixture of any two or more thereof. In some

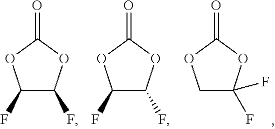

embodiments, the compound is: or a mixture of any two or more thereof.

### BRIEF DESCRIPTION OF THE DRAWINGS

FIG. 1 is a voltage v. time graph for the lithium lithium symmetric cell results in two different electrolytes: 1 M LiPF₆ in DFEC/EMC 11 and 1.2 M LiPF₆ in EC/EMC 37, according to Example 1.

FIG. 2 is a voltage v. time graph for the lithium lithium symmetric cell results in three different electrolytes: 0.4 M LiB(C₂O₄)₂ and 0.6 M LiTFSI and 0.05 M LiPF₆ in EC/EMC (23); 1.2 M LiPF₆ in DFEC/EMC 19 and 1.2 M LiPF₆ in DFEC/EMC 11, according to Example 2.

FIG. 3 is linear sweep voltammograms for 1.2 M LiPF₆ EC/EMC (3:7); 1.0 M LiPF₆ TFPC/FEMC (3:7); 1.0 M LiPF₆ FEC/FEMC (3:7); and 1.0 M LiPF₆ DFEC/FEMC (3:7), using a three-electrode system (Pt working electrode, lithium counter electrode and lithium reference electrode), according to Example 3.

FIG. 4 is a discharge capacity vs. cycle number graph for Li₁Ni_{0.6}Mn_{0.2}CO_{0.2}O₂Li metal 2032 coin cells using various electrolytes: 1.2 M LiPF₆ EC/EMC (3:7); 1.2 M LiPF₆ FEC/FEMC (3:7); 1.2 M LiPF₆ TFPC/FEMC (3:7); and 1.2 M LiPF₆ DFEC/FEMC (3:7), during cycling from 3.0 V to 4.4 Vat a current of C/3, according to Example 4.

FIG. 5 is a graph showing the Coulombic efficiency profiles for Li⁰Li₁Ni_{0.6}Mn_{0.2}CO_{0.2}O₂ 2032 coin cells using various electrolytes: 1.2 M LiPF₆ EC/EMC (3:7); 1.2 M LiPF₆ FEC/FEMC (3:7); 1.2 M LiPF₆ TFPC/FEMC (3:7); and 1.2 M LiPF₆ DFEC/FEMC (3:7), during cycling from 3.0 V to 4.4 V at a current of C/2, according to Example 4.

FIG. 6 is a magnification photograph of the cross section of harvested Li metal in the baseline electrolyte after cycling tests, according to Example 5.

FIG. 7 is a magnification photograph of the cross section of harvested Li metal, especially the Li dendrite part, in the baseline electrolyte after cycling tests, according to Example 5.

FIG. 8 is a magnification photograph of the cross section of harvested Li metal in the DFEC/EMC electrolyte after cycling tests, according to Example 6.

FIG. 9 is a magnification photograph of the top view of harvested Li metal in the DFEC/EMC electrolyte after cycling tests, according to Example 6.

FIG. 10 is a discharge capacity vs. cycle number graph for Li₁Ni_{0.6}Mn_{0.2}CO_{0.2}O₂Li metal 2032 coin cells using 1.2 M LiPF₆ DFEC/EMC (3:7) and 1.2 M LiPF₆ FEC/EMC (3:7), where the cells were cycled from 3.0 V to 4.4 V at a current of C/3, according to Example 7.

FIG. 11 is a graph illustrating the Coulombic efficiency profiles for Li metal Li₁Ni_{0.6}Mn_{0.2}CO_{0.2}O₂ 2032 coin cells using 1.2 M LiPF₆ DFEC/EMC (3:7) and 1.2 M LiPF₆ FEC/EMC (3:7), where the cells were cycled from 3.0 V to 4.4 V at a current of C/3, according to Example 7.

FIG. 12 is a discharge capacity v. cycle number graph for Li₁Ni_{0.6}Mn_{0.2}Co_{0.2}O₂Li metal 2032 coin cells using: 1.2 M LiPF₆ EC/EMC (3:7), 0.4 M LiB(C₂O₄)₂, 0.6 M LiTFSI, 0.05 M LiPF₆ EC/EMC (4:6), 1.2 M LiPF₆ DFEC/EMC (1:1) and 1.2 M LiPF₆ DFEC/EMC (1:1) (0.02 M LiB(C₂O₄)₂), where the cells were cycled from 3.0 V to 4.4 V at a current of C/2, according Example 8.

FIG. 13 is a graph of the Coulombic efficiency profiles for Li metal Li₁Ni_{0.6}Mn_{0.2}Co_{0.2}O₂ 2032 coin cells using 1.2 M LiPF₆ EC/EMC (3:7), 0.4 M LiB(C₂O₄)₂, 0.6 M LiTFSI, 0.05 M LiPF₆ EC/EMC (4:6), 1.2 M LiPF₆ DFEC/EMC (1:1) and 1.2 M LiPF₆ DFEC/EMC (1:1) (0.02 M LiB(C₂O₄)₂), where the cells were cycled from 3.0 V to 4.4 V at a current of C/2, according to Example 8.

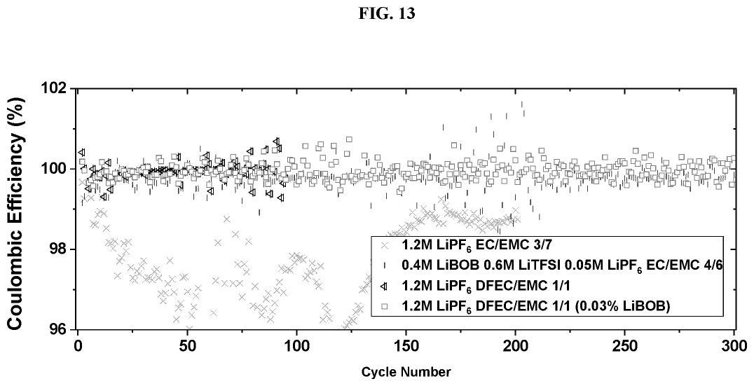

### DETAILED DESCRIPTION

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s).

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

In general, “substituted” refers to an alkyl, alkenyl, alkynyl, aryl, or ether group, as defined below (e.g., an alkyl group) in which one or more bonds to a hydrogen atom contained therein are replaced by a bond to non-hydrogen or non-carbon atoms. It should be noted that unless otherwise indicated any alkyl, alkenyl, alkynyl, aryl, ether, ester, or the like may be substituted, whether indicated as substituted or not. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

As used herein, “alkyl” groups include straight chain and branched alkyl groups having from 1 to about 20 carbon atoms, and typically from 1 to 12 carbons or, in some embodiments, from 1 to 8 carbon atoms. As employed herein, “alkyl groups” include cycloalkyl groups as defined below. Alkyl groups may be substituted or unsubstituted. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups may be substituted or unsubstituted. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to about 20 carbon atoms, and further including at least one double bond. In some embodiments alkenyl groups have from 1 to 12 carbons, or, typically, from 1 to 8 carbon atoms. Alkenyl groups may be substituted or unsubstituted. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

As used herein, “aryl”, or “aromatic,” groups are cyclic aromatic hydrocarbons that do not contain heteroatoms. Aryl groups include monocyclic, bicyclic and polycyclic ring systems. Thus, aryl groups include, but are not limited to, phenyl, azulenyl, heptalenyl, biphenylenyl, indacenyl, fluorenyl, phenanthrenyl, triphenylenyl, pyrenyl, naphthacenyl, chrysenyl, biphenyl, anthracenyl, indenyl, indanyl, pentalenyl, and naphthyl groups. In some embodiments, aryl groups contain 6-14 carbons, and in others from 6 to 12 or even 6-10 carbon atoms in the ring portions of the groups. The phrase “aryl groups” includes groups containing fused rings, such as fused aromatic-aliphatic ring systems (e.g., indanyl, tetrahydronaphthyl, and the like). Aryl groups may be substituted or unsubstituted.

Provided herein are electrochemical cells that are based upon a lithium metal anode and having electrolytes that improve upon cycling stability, coulombic efficiency, and SEI formation in such cells when compared to electrochemical cells having lithium anodes but without the specified electrolytes. The electrolytes include a difluoroethylene carbonate, or mixture thereof as the primary solvent. Such cells are distinct from lithium ion batteries in which the anode includes a porous material in which lithium is intercalated and de-intercalated during charging and discharging, respectively. In the present cells, the lithium is stripped from the lithium metal anode during discharge and plated onto the anode during charging, without the presence of a porous material to allow for intercalation and de-intercalation. The lithium metal anodes of the present application are significantly more reactive than traditional graphite anodes used in lithium ion batteries. Accordingly, the degree of parasitic reaction with conventional electrolytes is also much higher for lithium metal anode-based cells, however the electrolytes disclosed herein surprisingly control the side reactions to provide a stable, lithium metal anode-based electrochemical cells. Moreover, lithium metal anodes may form dendrites which impose enormous safety issues on the battery, however with the use of the difluoroethylene carbonate solvents as described herein, these adverse effects are largely suppressed.

In one aspect, an electrochemical cell is provided having a lithium metal anode. The cells have stable electrolytes that enable lithium plating to, and stripping from, the anode during charging and discharging processes, respectively. The electrochemical cells include a cathode comprising a cathode active material, a separator between the anode and the cathode, and an electrolyte. The electrolytes include a lithium salt, an organic aprotic solvent, and a difluoroethylene carbonate (DFEC), or a mixture thereof.

The DFEC may include one or more of:

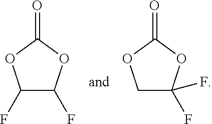 [SMILES: O=C1OC(F)C(F)O1 ; "and" ; O=C1OCC(F)(F)O1]

This includes the stereospecific compounds

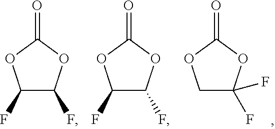

or a mixture thereof. The DFEC may be present in an amount from about 0.05 vol % to about 80 vol %, based upon the total volume of the electrolyte. This may include from about 0.05 vol % to about 60 vol %; from about 1 vol % to about 60 vol %; from about 5 vol % to about 80 vol %; from about 5 vol % to about 60 vol %; from about 5 vol % to about 10 vol %; from about 10 vol % to about 80 vol %; or from about 10 vol % to about 50 vol %, based upon the total volume of the electrolyte.

As used herein, the term “organic aprotic solvent” refers to liquids that lack exchangeable hydrogens, but have functional groups that impart polarity (e.g., as evidenced by dielectric constant) to the solvent.

The organic aprotic solvent may be organic carbonate, fluorinated carbonate, ether, fluorinated ether, glyme, sulfone, organic sulfate, ester, cyclic ester, fluorinated ester, nitrile, amide, dinitrile, fluorinated amide, carbamate, fluorinated carbamate and cyanoester compounds. Illustrative organic aprotic solvents include, but are not limited to, a compound represented by one or more of:

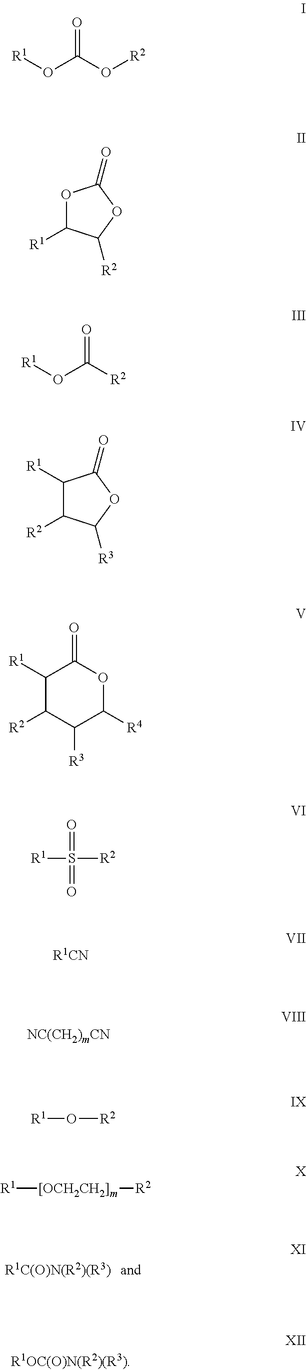

In the above compounds, R¹, R², R³, and R⁴ are individually are individually H, F, Cl, Br, I, CN, oxo, OR⁵, alkyl, alkenyl, alkynyl, silyl, siloxy, —C(O)R⁶, —C(O)OR⁶, or —OC(O)R⁶; R⁵ may be H, alkyl, alkenyl, alkynyl, aryl, aralkyl, or heterocyclyl; R⁶ may be H, alkyl, alkenyl, alkynyl, aryl, aralkyl, or heterocyclyl; with the proviso that the organic aprotic solvent is not a difluoroethylene carbonate; and m is 1, 2, 3, 4, 5, or 6. In some embodiments, in any individual compound of Formulas I-XII at least one of R₁, R₂, R³, and R⁴ is F or a fluorinated group. In other embodiments, any individual compound of Formulas I-XII at least one of R¹, R², R³, and R⁴ is F, CₙHₓF_{y}, CH₂CₙHₓF_{y}, CH₂OCH_{x-y}F_{y}, or CF₂OCHₓF_{y}; n is 1, 2, 3, 4, 5, 6, 7, 8, 9, 10, 11, or 12; x is 1, 2, or 3; and y is 0, 1, 2, or 3.

Illustrative, organic aprotic solvent may include but is not limited to ethylene carbonate, fluoroethylene carbonate, 4-(trifluoromethyl)-1,3-dioxolan-2-one, propylene carbonate, dimethyl carbonate, ethyl methyl carbonate, diethyl carbonate, methyl propyl carbonate, ethyl propyl carbonate, dipropyl carbonate, bis(trifluoroethyl) carbonate, bis(pentafluoropropyl) carbonate, trifluoroethyl methyl carbonate, pentafluoroethyl methyl carbonate, trifluoroethyl ethyl carbonate, heptafluoropropyl ethyl carbonate, hexafluoroisopropyl methyl carbonate, pentafluoroethyl ethyl carbonate, pentafluorobutyl methyl carbonate, pentafluorobutyl ethyl carbonate, dimethoxyethane, triglyme, dimethyl ether, diglyme, tetraglyme, dimethyl ethylene carbonate, ethyl acetate, trifluoroethyl acetate, ethyl methyl sulfone, sulfolane, methyl isopropyl sulfone, butyrolactone, acetonitrile, succinonitrile, methyl 2-cyanoacetate, N,N-dimethylacetamide, 2,2,2-trifluoro-N,N-dimethylacetamide, methyl dimethylcarbamate, 2,2,2-trifluoroethyl dimethylcarbamate, and mixtures of any two or more thereof

In other embodiments, the organic aprotic solvent in the electrolyte may be a pyrrolidinium-based, piperidinium-based, imidazolium-based, ammonium-based, phosphonium-based, cyclic phosphonium-based ionic liquid, or a mixture of any two or more thereof. In some embodiments, the counterion, X⁻, of the ionic liquid is N(CF₃SO₂)₂⁻, N(FSO₂)₂⁻, MCF₃CF₂SO₂)₂⁻, C(CF₃SO₂)₃⁻, CF₃SO₃⁻, CF₃CO₂, N(CN)₂⁻, C₂F₅CO₂⁻, ClO₄⁻, BF₄⁻, AsF₆⁻, PF₆⁻, PF₂(C₂O₄)₂⁻, PF₄(C₂O₄)⁻, BF₂(C₂O₄)⁻, B(C₂O₄)₂⁻, alkyl fluorophosphates, Li₂(B₁₂X₁₂₋ᵢHᵢ); Li₂(B₁₀X_{10-I′}H_{i′}); and a mixture of any two or more thereof, wherein X is independently at each occurrence a halogen, I is an integer from 0 to 12 and I′ is an integer from 0 to 10.

In some embodiments, ionic liquid is a room temperature ionic liquid. Exemplary ionic liquids include but are not limited to imidazolium salts such as 1-ethyl-3-methyl-imidazolium bis(trifluoromethanesulfonyl)imide, 1-ethyl-3-methyl-imidazolium bis(fluorosulfonyl)imide, 1-ethyl-2,3-dimethyl-imidazolium bis(trifluoromethanesulfonyl)imide, 1-ethyl-2,3-dimethyl-imidazolium bis(fluorosulfonyl)imide, 1-methyl-3-ethyl-imidazolium bis(trifluoromethanesulfonyl)imide, 1-methyl-3-ethyl-imidazolium bis(fluorosulfonyl)imide, 1-ethyl-3-(2-methoxyethoxymethyl)-1H-imidazol-3-ium bis(trifluoromethanesulfonyl)imide, 1-ethyl-3-(2-methoxyethoxymethyl)-1H-imidazol-3-ium bis(fluorosulfonyl)imide, 1-n-butyl-3-methyl-imidazolium bis(trifluoromethanesulfonyl)imide, 1-n-butyl-3-methyl-imidazolium bis(fluorosulfonyl)imide, 3-ethyl -1-(2-methoxyethyl)-1H-imidazol -3-ium bis(trifluoromethanesulfonyl)imide, 3-ethyl-1-(2-methoxyethyl)-1H-imidazol-3 -ium bis(fluorosulfonyl)imide; pyrrolidinium salts such as 1-butyl-1-methylpyrrolidinium bis(trifluoromethanesulfonyl)imide, 1-butyl -1-methylpyrrolidinium bis(fluorosulfonyl)imide, 1-ethyl-1-methylpyrrolidinium bis(trifluoromethanesulfonyl)imide, 1-ethyl-1-methylpyrrolidinium bis(fluorosulfonyl)imide, 1-methyl-1-propylpyrrolidinium bis(trifluoromethanesulfonyl)imide, 1-methyl-1-propylpyrrolidinium bis(fluorosulfonyl)imide, 1-(2-methoxyethyl)-1-ethylpyrrolidinium bis(trifluoromethanesulfonyl)imide, 1-(2-methoxyethyl)-1-ethylpyrrolidinium bis(fluorosulfonyl)imide; piperidinium salts such as 1-butyl-1-methylpiperidinium bis(trifluoromethanesulfonyl)imide, 1-butyl-1-methylpiperidinium bis(fluorosulfonyl)imide, 1-methyl-1-propyl piperidinium bis(trifluoromethanesulfonyl)imide, 1-methyl-1-propyl piperidinium bis(fluorosulfonyl)imide, 1-(2-methoxyethyl)-1-ethylpiperidinium bis(trifluoromethanesulfonyl)imide, 1-(2-methoxyethyl)-1-ethylpiperidinium bis(fluorosulfonyl)imide; phosphonium salts such as triethyl(2-methoxyethyl)phosphonium bis(trifluoromethanesulfonyl)imide, triethyl(2-methoxyethyl)phosphonium bis(fluorosulfonyl)imide, tripropyl(2-methoxyethyl)phosphonium bis(trifluoromethanesulfonyl)imide, tripropyl(2-methoxyethyl)phosphonium bis(fluorosulfonyl)imide, tributyl(2-methoxyethyl)phosphonium bis(trifluoromethanesulfonyl)imide, tributyl(2-methoxyethyl)phosphonium bis(fluorosulfonyl)imide, tetraethylphosphonium bis(trifluoromethanesulfonyl)imide, tetraethylphosphonium bis(fluorosulfonyl)imide, tetrabutylphosphonium bis(trifluoromethanesulfonyl)imide, tetrabutylphosphonium bis(fluorosulfonyl)imide, tributylmethylphosphonium bis(trifluoromethanesulfonyl)imide, tributylmethylphosphonium bis(fluorosulfonyl)imide, triethylbutylphosphonium bis(trifluoromethanesulfonyl)imide and triethylbutylphosphonium bis(fluorosulfonyl)imide.

In further embodiments, the electrolyte may further include an aprotic gel polymer. For example, mixtures of poly(ethylene oxide) (PEO) with lithium salts and an organic aprotic solvent may be used.

Suitable salts for the electrolyte may include, but are not limited to, lithium alkyl fluorophosphates; lithium alkyl fluoroborates; lithium 4,5-dicyano-2-(trifluoromethyl)imidazole; lithium 4,5-dicyano-2-methylimidazole; trilithium 2,2′,2″-tris(trifluoromethyl)benzotris(imidazolate); Li(CF₃CO₂); Li(C₂F₅CO₂); LiCF₃SO₃; LiCH₃SO₃; LiN(SO₂CF₃)₂; LiC(CF₃SO₂)₃; LiN(SO₂C₂F₅)₂; LiClO₄; LiBF₄; LiAsF₆; LiPF₆; LiPF₂(C₂O₄)₂; LiPF₄(C₂O₄); LiB(C₂O₄)₂; LiBF₂(C₂O₄)₂; Li₂(B₁₂X₁₂₋ᵢHᵢ); Li₂(B₁₀X_{10-I′}H_{i′}; and a mixture of any two or more thereof, wherein X is independently at each occurrence a halogen, I is an integer from 0 to 12 and I′ is an integer from 0 to 10. The salt may be present in the electrolyte at a concentration from about 0.5M to 2M.

In some embodiments, the electrolyte may also contain an electrode stabilizing additive such as but is not limited to LiB(C₂O₄)₂, LiBF₂(C₂O₄)₂, vinylene carbonate, vinyl ethylene carbonate, propargylmethyl carbonate, 1,3,2-dioxathiolane-2,2-dioxide, ethylene sulfite, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, anisoles, 2,5-dimethyl-1,4-dimethoxybenzene, 2,3,5,6-tetramethyl-1,4-dimethoxybenzene, 2,5-di-tert-butyl-1,4-dimethoxybenzene, or a mixture of two or more thereof. However, where the electrode stabilizing additive contains lithium, and when used, it is not the same as the lithium salt.

In some embodiments, the electrolyte may also include a redox shuttle material. The shuttle, if present, will have an electrochemical potential above the positive electrode's maximum normal operating potential. Illustrative stabilizing agents include, but are not limited to, a spirocyclic hydrocarbon containing at least one oxygen atom and at least on alkenyl or alkynyl group, pyridazine, vinyl pyridazine, quinolone, pyridine, vinyl pyridine, 2,4-divinyl-tetrahydrooyran, 3,9-diethylidene-2,4,8-trioxaspiro[5,5]undecane, 2-ethylidene-5-vinyl-[1,3]dioxane, lithium alkyl fluorophosphates, lithium alkyl fluoroborates, lithium 4,5-dicyano-2-(trifluoromethyl)imidazole, lithium 4,5-dicyano-2-methylimidazole, trilithium 2,2′,2″-tris(trifluoromethyl)benzotris(imidazolate), Li(CF₃CO₂), Li(C₂F₅CO₂), LiCF₃SO₃, LiCH₃SO₃, LiN(SO₂CF₃)₂, LiC(CF₃SO₂)₃, LiN(SO₂C₂F₅)₂, LiClO₄, LiAsF₆, Li₂(B₁₂X₁₂₋ᵢHᵢ), Li2(B₁₀X_{10-I′}H_{i′}), wherein X is independently at each occurrence a halogen, I is an integer from 0 to 12 and I′ is an integer from 0 to 10, 1,3,2-dioxathiolane 2,2-dioxide, 4-methyl-1,3,2-dioxathiolane 2,2-dioxide, 4-(trifluoromethyl)-1,3,2-dioxathiolane 2,2-dioxide, 4-fluoro-1,3,2-dioxathiolane 2,2-dioxide, 4,5-difluoro-1,3,2-dioxathiolane 2,2-dioxide, dimethyl sulfate, methyl (2,2,2-trifluoroethyl) sulfate, methyl (trifluoromethyl) sulfate, bis(trifluoromethyl) sulfate, 1,2-oxathiolane 2,2-dioxide, methyl ethanesulfonate, 5-fluoro-1,2-oxathiolane 2,2-dioxide, 5-(trifluoromethyl)-1,2-oxathiolane 2,2-dioxide, 4-fluoro-1,2-oxathiolane 2,2-dioxide, 4-(trifluoromethyl)-1,2-oxathiolane 2,2-dioxide, 3-fluoro-1,2-oxathiolane 2,2-dioxide, 3-(trifluoromethyl)-1,2-oxathiolane 2,2-dioxide, difluoro-1,2-oxathiolane 2,2-dioxide, 5H-1,2-oxathiole 2,2-dioxide, 2,5-dimethyl-1,4-dimethoxybenzene, 2,3,5,6-tetramethyl-1,4-dimethoxybenzene, 2,5-di-tert-butyl-1,4-dimethoxybenzene or a mixture of any two or more thereof, with the proviso that when used, the redox shuttle is not the same as the lithium salt, even though they perform the same function in the cell. That is, for example, if the lithium salt is LiClO₄, it may also perform the dual function of being a redox shuttle, however if a redox shuttle is included in that same cell, it will be a different material than LiClO₄.

The lithium batteries include a cathode. The cathode includes a cathode active material which may be, but is not limited to, a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMnₖCoₗMe²_{y′}O_{2-z′}F_{z′}, VO₂ or E_{x″}F₂(Me₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ<1; 0≤h≤1; 0≤k≤1; 0≤l<1; 0≤y′≤0.4; 0≤z′≤0.4; and 0≤x″≤3; with the proviso that at least one of h, k and 1 is greater than 0.

The term “spinel” refers to a manganese-based spinel such as, Li₁₊ₓMn_{2-y}Me_{z}O₄₋ₕAₖ, wherein Me is Al, Mg, Ti, B, Ga, Si, Ni, or Co; A is S or F; and wherein 0≤x≤0.5, 0≤y≤0.5, 0≤z≤0.5, 0≤h≤0.5, and 0≤k≤0.5.

The term “olivine” refers to an iron-based olivine such as, LiFe₁₋ₓMe_{y}PO₄₋ₕAₖ, wherein Me is Al, Mg, Ti, B, Ga, Si, Ni, or Co; A is S or F; and wherein 0≤x≤0.5, 0≤y≤0.5, 0≤h≤0.5, and 0≤k≤0.5.

The cathode may be further stabilized by surface coating the active particles with a material that can neutralize acid or otherwise lessen or prevent leaching of the transition metal ions. Hence, the cathodes may also include a surface coating of a metal oxide or fluoride such as ZrO₂, TiO₂, ZnO₂, WO₃, Al₂O₃, MgO, SiO₂, SnO₂, AlPO₄, Al(OH)₃, AlF₃, ZnF₂, MgF₂, TiF₄, ZrF₄, a mixture of any two or more thereof, of any other suitable metal oxide or fluoride. The coating can be applied to a carbon coated cathode.

The cathode may be further stabilized by surface coating the active particles with polymer materials. Examples of polymer coating materials include, but not limited to, polysiloxanes, polyethylene glycol, or poly(3,4-ethylenedioxythiophene) polystyrene sulfonate, a mixture of any two or more polymers.

The electrodes of the lithium batteries may also include a current collector. Current collectors for either the anode or the cathode may include those of copper, stainless steel, titanium, tantalum, platinum, gold, aluminum, nickel, cobalt, cobalt nickel alloy, highly alloyed ferritic stainless steel containing molybdenum and chromium; or nickel-, chromium-, or molybdenum containing alloys.

The electrodes (i.e., the cathode and/or the anode) may also include a conductive polymer. Illustrative conductive polymers include, but not limited to, polyaniline, polypyrrole, poly(pyrrole-co-aniline), polyphenylene, polythiophene, polyacetylene, polysiloxane, polyvinylidene difluoride, or polyfluorene.

The lithium batteries disclosed herein also includes a porous separator to separate the cathode from the anode and prevent, or at least minimize, short-circuiting in the device. The separator may be a polymer or ceramic or mixed separator. The separator may include, but is not limited to, polypropylene (PP), polyethylene (PE), trilayer (PP/PE/PP), or polymer films that may optionally be coated with alumina-based ceramic particles.

The present invention, thus generally described, will be understood more readily by reference to the following examples, which are provided by way of illustration and are not intended to be limiting of the present invention.

### EXAMPLES

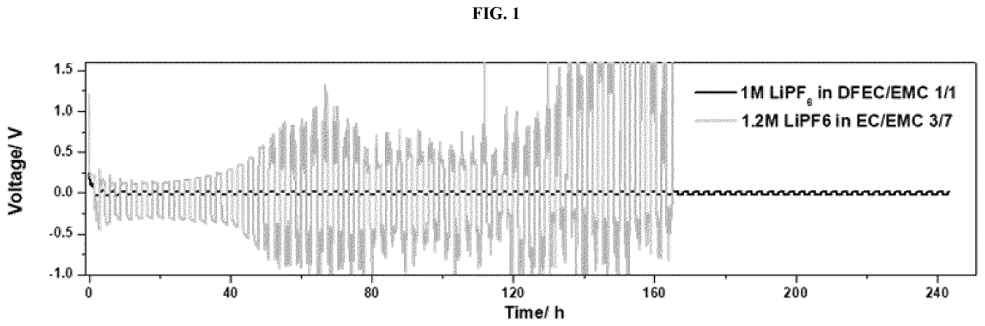

Example 1. A LiLi symmetric cell was used to investigate the plating/stripping stability of a Li metal anode in different electrolytes at a 2mAcm² current density over 240 hours. The results are displayed in FIG. 1. The cell cycled in the baseline electrolyte shows a high voltage polarization, which indicates a high impedance interface due to the growth of the lithium dendrite. Meanwhile, for the cell cycled in the DFEC/EMC electrolyte, it shows good cycling stability and demonstrates that the DFEC/EMC based electrolyte can enable the reversible plating/stripping of Li⁺ on the Li metal electrode.

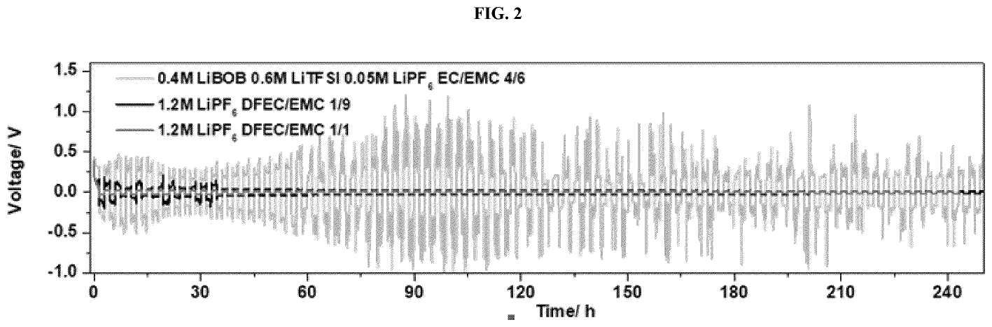

Example 2. A LiLi symmetric cell was used to investigate the plating/stripping stability of a Li metal anode in different electrolytes at a 2mAcm² current density for over 240 hours. The results are displayed in FIG. 2. The cell was cycled in 0.4 M LiB(C₂O₄)₂ (“LiBOB”), 0.6 M LiTFSI, 0.05 M LiPF₆ in EC/EMC (2:3) electrolyte. The cell exhibits a high voltage polarization and cannot be stabilized in the further cycling, which indicates that the electrolyte formulation does form a good SEI on the Li metal electrode, thereby enabling the Li⁺ plating and stripping. For the cell cycled in 1.2 M LiPF₆ DFEC/EMC (1:9), it too shows a high polarization in the initial 10 cycles, but the voltage is stabilized after that due to a good SEI formed by the DFEC on the Li metal. For the cell cycled in 1.2 M LiPF₆ DFEC/EMC (1:1), a good SEI was formed and can initiate the Li⁺ plating/stripping.

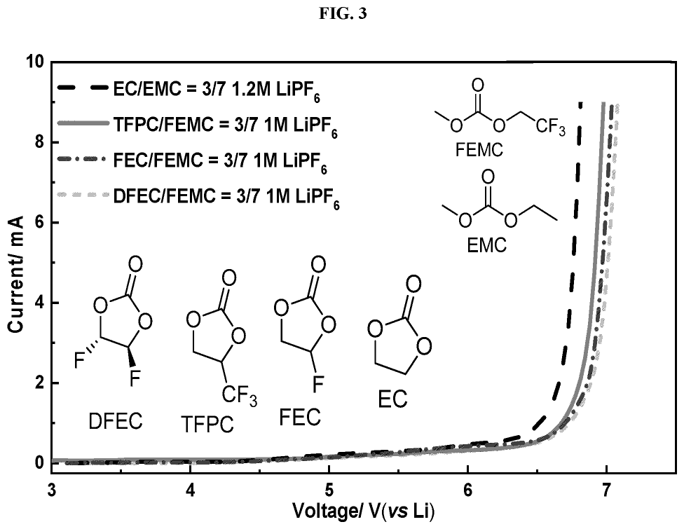

Example 3. FIG. 3 shows the linear sweep voltammograms of electrolytes of 1.2 M LiPF₆ in EC/EMC (3:7); 1.0 M LiPF₆ in TFPC/FEMC (3:7); 1.0 M LiPF₆ in FEC/FEMC (3:7); and 1.0 M LiPF₆ in DFEC/FEMC (3:7) using a three-electrode system (Pt working electrode, lithium counter electrode and lithium reference electrode). For the 1.2 M LiPF₆ in EC/EMC (3:7) electrolyte, the oxidation reaction was triggered at about 6.5 V vs. Li. For the 1.0 M LiPF₆ in TFPC/FEMC (3:7) electrolyte, the oxidation reaction was triggered at about 6.6 V vs. Li. For the 1.0 M LiPF₆ in FEC/FEMC (3:7) electrolyte, the oxidation reaction was triggered at about 6.65 V vs. Li. Finally, for the 1.0 M LiPF₆ in DFEC/FEMC (3:7) electrolyte, the oxidation reaction was triggered at about 6.7 V vs. Li. Therefore, the DFEC-based electrolyte shows the highest anodic stability.

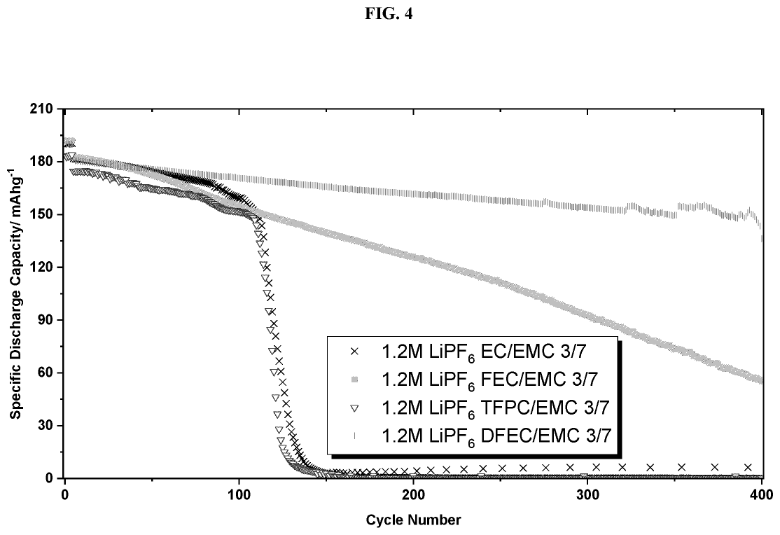

Example 4. FIG. 4 shows the discharge capacity of LiNi_{0.6}Mn_{0.2}Co_{0.2}O₂/Li metal 2032 coin cells using 1.2 M LiPF₆ in EC/EMC (3:7); 1.0 M LiPF₆ in TFPC/FEMC (3:7); 1.0 M LiPF₆ in FEC/FEMC (3:7); and 1.0 M LiPF₆ in DFEC/FEMC (3:7) electrolytes. The coin cells were cycled from 3.0 V to 4.4 V at a current of C/2. The cell using DFEC based electrolyte shows the best capacity retention (88% after 400 cycles), while the cell using baseline electrolyte 1.2 M LiPF₆ in EC/EMC (3:7) cannot be cycled after 120 cycles.

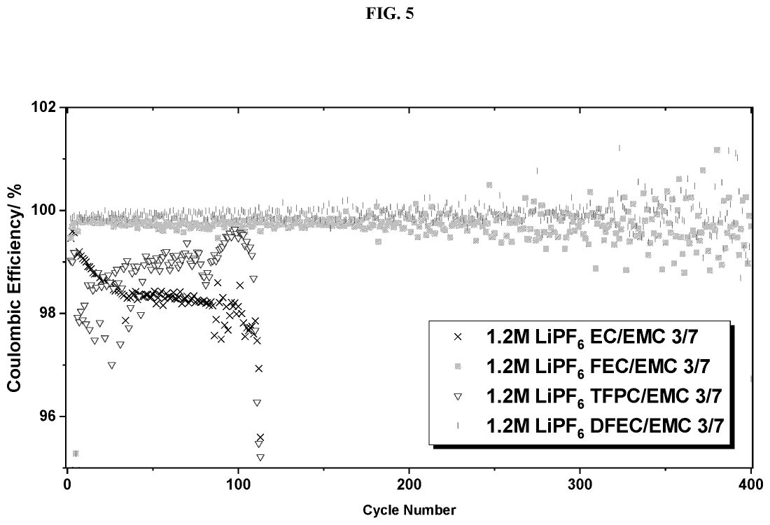

FIG. 5 shows the Coulombic efficiency of the above cells. The above cells all have Coulombic efficiency larger than 99.5% except the cells using 1.0 M LiPF₆ in TFPC/FEMC (3:7), and the baseline electrolyte with Coulombic efficiencies drop dramatically after 120 cycles because of Li dendrite formation and dead Li formation on the Li electrode surface. It also indicates that the cell using 1.0 M LiPF₆ in DFEC/FEMC (3:7) as an electrolyte shows superior capacity retention over those of all others electrolyte. As used herein, “dead lithium” is a mixture of non-recyclable lithium components including LiF, various lithium oxides, lithium carbonate, and other lithium by-products.

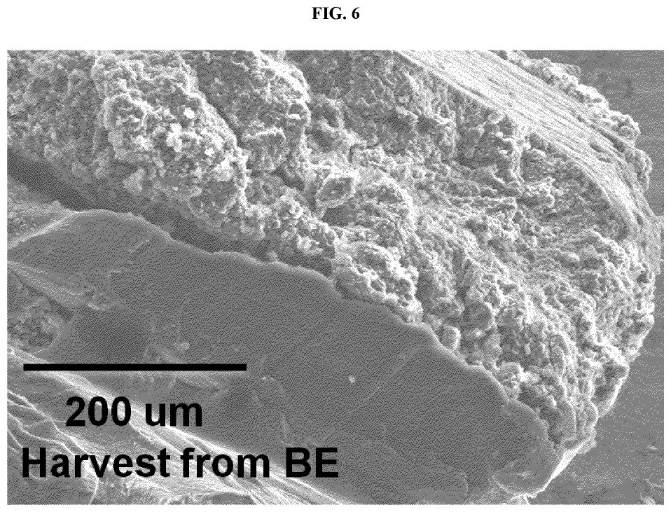

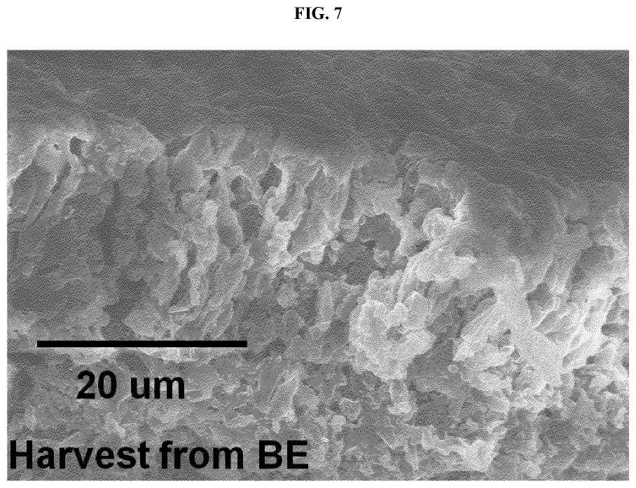

Example 5. FIG. 6 and FIG. 7 show the cross section of harvested Li metal from the cells after cycling in the baseline electrolyte (1.2 M LiPF₆ in EC/EMC (3:7)). The cell with the baseline electrolyte cannot form a robust SEI on the surface, thus leading to cracking and significant, sporadic needle-like dendritic Li on the surface. It will not only increase the surface impedance, but also will lead the decay of capacity and Coulombic efficiency.

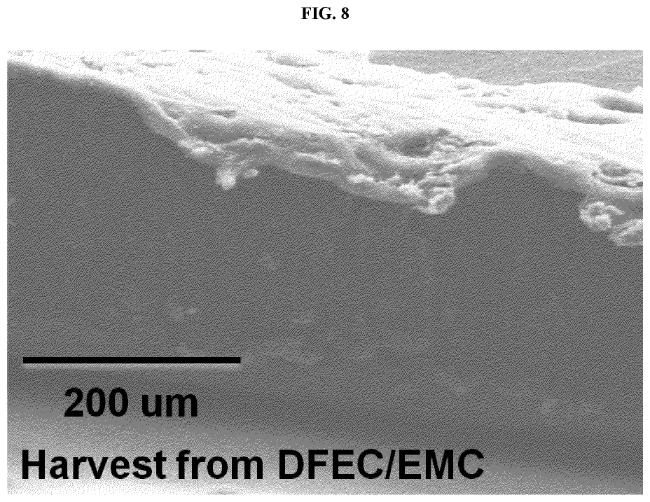

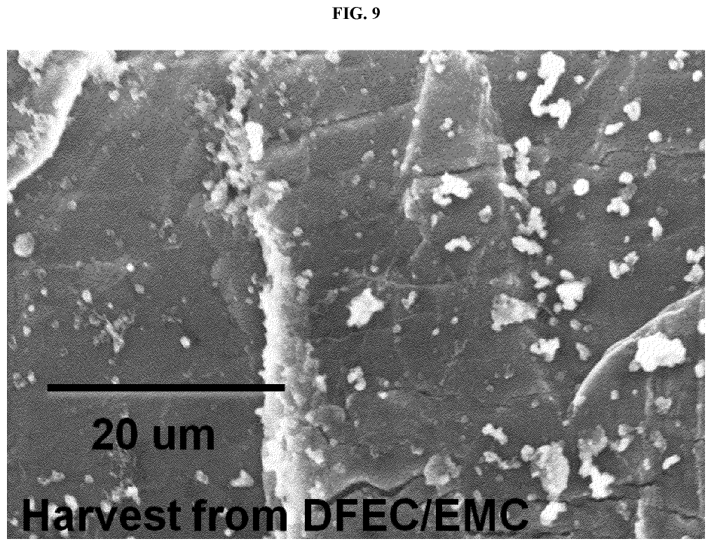

Example 6. FIG. 8 and FIG. 9 show the cross section and top view of harvested Li metal after cycled in the DFEC/FEMC electrolyte. The cell showed robust SEI formation on the surface, which is believe to inhibit the further electrolyte decomposition and Li dendrite formation. FIG. 8 shows the major part of the bulk Li metal anode was well maintained. From the top view (FIG. 9), a flat interface is observed with few cracks, and no Li dendrite formation or dead Li metal. It also indicates that, comparing with the baseline cell, the impedance can be better maintained by a good SEI formed by DFEC.

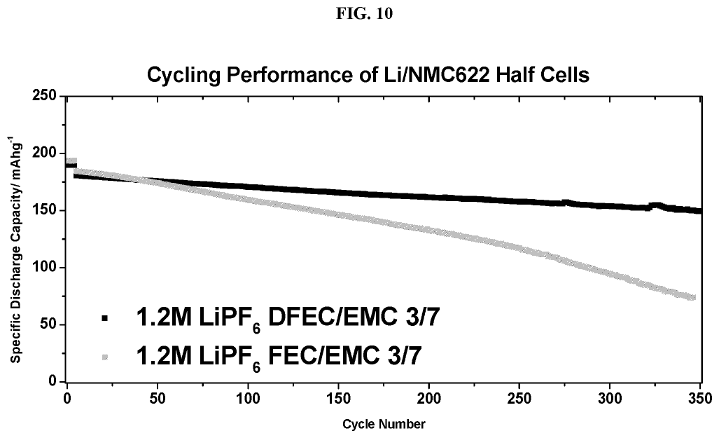

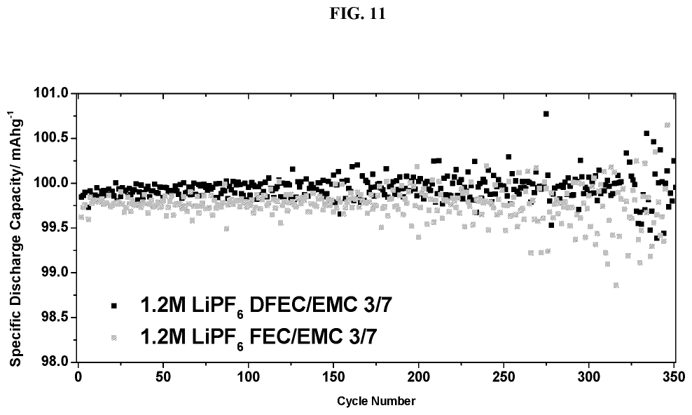

Example 7. FIG. 10 is a graph of the discharge capacity of Li₁Ni_{0.6}Mn_{0.2}Co_{0.2}O₂ Li metal 2032 coin cells using 1.2 M LiPF₆ in DFEC/EMC (3:7) and 1.2 M LiPF₆ in FEC/EMC (3:7) electrolytes. The coin cells were cycled from 3.0 V to 4.4 V at a current of C/3. The cell using DFEC based electrolyte shows better capacity retention (83% after 350 cycles), while the cell using 1.2 M LiPF₆ in FEC/EMC (3:7) displays 40% capacity retention after 350 cycles. FIG. 11 shows the Coulombic efficiency of the above cells, which is greater than 99.5%, with the DFEC-based electrolyte cell showed higher efficiency than the FEC based cell.

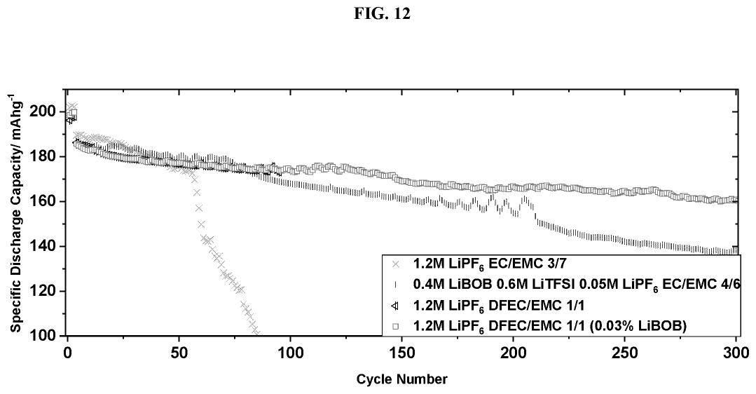

Example 8. FIG. 11 shows the discharge capacity of LiNi_{0.6}Mn_{0.2}Co_{0.2}O₂ Li graphite 2032 coin cells using electrolytes of 1.2 M LiPF₆ in EC/EMC (3:7); 0.4 M LiB(C₂O₄)₂ (“LiBOB”), 0.6 M LiTFSI, 0.05 M LiPF₆ in EC/EMC (4:6); 1.2 M LiPF₆ in DFEC/EMC (1:1); and 1.2 M LiPF₆ in DFEC/EMC (1:1) (0.02 M LiBOB). The coin cells were cycled from 3.0 V to 4.4 V at a current of C/2. The cell using 1.2 M LiPF₆ in DFEC/EMC (1:1) (0.02 M LiBOB) electrolyte demonstrates significantly better cycling performance than the cell using other electrolytes. FIG. 12 shows the Coulombic efficiency of the above cells. The cell with 1.2 M LiPF₆ in DFEC/EMC (1:1) (0.02 M LiBOB) electrolyte exhibited the highest efficiency.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims. what is claimed is:

1. An electrochemical cell comprising:
a cathode comprising a cathode active material;
an anode comprising lithium metal (Li⁰);
a separator; and
an electrolyte comprising a lithium salt, an organic aprotic solvent, and a difluoroethylene carbonate which is: 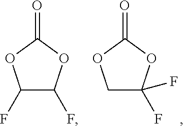
or a mixture of any two or more thereof.

2. The electrochemical cell of claim 1, wherein the compound is: 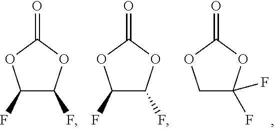
or a mixture of any two or more thereof.

3. The electrochemical cell of claim 1 further comprising an electrolyte stabilizing additive that is LiBF₂(C₂O₄), LiB(C₂O₄)₂, LiPF₂(C₂O₄)₂, LiPF₄(C₂O₄), LiPF₆, LiAsF₆, CsF, CsPF₆, LiN(SO₂CF₃)₂, LiN(SO₂F)₂, Li₂(B₁₂X₁₂₋ᵢHᵢ); Li₂(B₁₀X_{10-i′}H_{i′});
or a mixture of any two or more thereof;
wherein X is independently at each occurrence a halogen, i is an integer from 0 to 12 and i′ is an integer from 0 to 10.

4. The electrochemical cell of claim 1, wherein the lithium salt is a lithium alkyl fluorophosphate; a lithium alkyl fluoroborate; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; Li(CF₃CO₂); Li(C₂F₅CO₂); LiCF₃SO₃; LiCH₃SO₃; LiN(SO₂CF₃)₂; LiN(SO₂F)₂; LiC(CF₃SO₂)₃; LiN(SO₂C₂F₅)₂; LiClO₄; LiBF₄; LiAsF₆; LiPF₆; LiPF₂(C₂O₄)₂; LiPF₄(C₂O₄); LiB(C₂O₄)₂; LiBF₂(C₂O₄)₂; Li_{z}(B₁₂X₁₂₋ᵢHᵢ); Li₂(B₁₀X_{10-I′}H_{i′}); and a mixture of any two or more thereof, wherein X is independently at each occurrence a halogen, I is an integer from 0 to 12 and I′ is an integer from 0 to 10.

5. The electrochemical cell of claim 3, wherein the lithium salt is a lithium alkyl fluorophosphate; a lithium alkyl fluoroborate; lithium 4,5-dicyano-2-(trifluoromethyl)imidazole; lithium 4,5-dicyano-2-methylimidazole; trilithium 2,2′,2″-tris(trifluoromethyl)benzotris(imidazolate); LiN(CN)₂; Li(CF₃CO₂); Li(C₂F₅CO₂); LiCF₃SO₃; LiCH₃SO₃; LiN(SO₂CF₃)₂; LiN(SO₂F)₂; LiC(CF₃SO₂)₃; LiN(SO₂C₂F₅)₂; LiClO₄; LiBF₄; LiAsF₆; LiPF₆; LiPF₂(C₂O₄)₂; LiPF₄(C₂O₄); LiB(C₂O₄)₂; LiBF₂(C₂O₄)₂; Li₂(B₁₂X₁₂₋ᵢHᵢ); Li₂(B₁₀X_{10-I′}H_{i′}); and a mixture of any two or more thereof, wherein X is independently at each occurrence a halogen, I is an integer from 0 to 12 and I′ is an integer from 0 to 10, with the proviso that the electrode stabilizing additive and the lithium salt are not the same material.

6. The electrochemical cell of claim 1, wherein the organic aprotic solvent is a compound represented by one or more of: 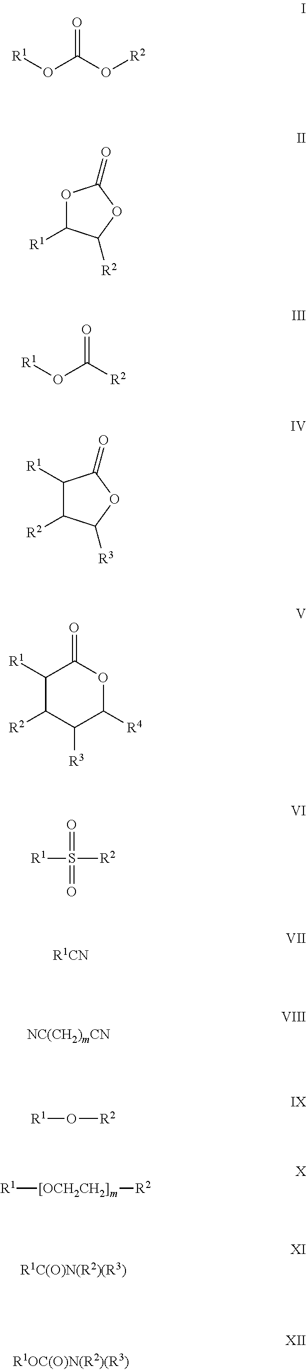
wherein:
R¹, R², R³, and R⁴ are individually are individually H, F, Cl, Br, I, CN, oxo, OR⁵, alkyl, alkenyl, alkynyl, silyl, siloxy, −C(O)R⁶, —C(O)OR⁶, or —OC(O)R⁶, with the proviso that the organic aprotic solvent is not a difluoroethylene carbonate;
R⁵ may be H, alkyl, alkenyl, alkynyl, aryl, aralkyl, or heterocyclyl;
R⁶ may be H, alkyl, alkenyl, alkynyl, aryl, aralkyl, or heterocyclyl; and
m is 1, 2, 3, 4, 5, or 6.

7. The electrochemical cell of claim 6, wherein in any individual compound of Formulas I-XII at least one of R¹, R², R³, and R⁴ is F or a fluorinated group.

8. The electrochemical cell of claim 7, wherein in any individual compound of Formulas I-XII at least one of R¹, R², R³, and R⁴ is F, CₙHₓF_{y}, CH₂CₙHₓF_{y}, CH₂OCH_{x-y}F_{y}, or CF₂OCHₓF_{y}; n is 1, 2, 3, 4, 5, 6, 7, 8, 9, 10, 11, or 12; x is 1, 2, or 3; and y is 0, 1, 2, or 3.

9. The electrochemical cell of claim 1, wherein the organic aprotic co-solvent in the electrolyte is pyrrolidinium-based, piperidinium-based, imidazolium-based, ammonium-based, phosphonium-based, cyclic phosphonium-based ionic liquid, or a mixture of any two or more thereof.

10. The electrochemical cell of claim 1, wherein the electrolyte further comprises an aprotic gel polymer.

11. The electrochemical cell of claim 1 which is a lithium secondary battery.

12. The electrochemical cell of claim 11, wherein the secondary battery is a lithium battery, a lithium-sulfur battery, or a lithium-air battery.

13. The electrochemical cell of claim 1, wherein the cathode active material comprises a spinel, an olivine, a carbon-coated olivine LiFePO₄, LiMn_{0.5}Ni_{0.5}O₂, LiCoO₂, LiNiO₂, LiNi₁₋ₓCo_{y}Me_{z}O₂, LiNi_{α}Mn_{β}Co_{γ}O₂, LiMn₂O₄, LiFeO₂, LiNi_{0.5}Me_{1.5}O₄, Li_{1+x′}NiₕMn_{K}CoₗMe²_{y′}O_{2-z′}F_{z′}, VO₂ or E_{x″}F₂(MeO₃O₄)₃, LiNiₘMnₙO₄, wherein Me is Al, Mg, Ti, B, Ga, Si, Mn, or Co; Me² is Mg, Zn, Al, Ga, B, Zr, or Ti; E is Li, Ag, Cu, Na, Mn, Fe, Co, Ni, or Zn; F is Ti, V, Cr, Fe, or Zr; wherein 0≤x≤0.3; 0≤y≤0.5; 0≤z≤0.5; 0≤m≤2; 0≤n≤2; 0≤x′≤0.4; 0≤α≤1; 0≤β≤1; 0≤γ≤1; 0≤h≤1; 0≤k≤1; 0≤l≤1; 0≤y′≤0.4; 0≤z′≤0.4; and 0≤x″ ≤3; with the proviso that at least one of h, k and l is greater than 0.

14. The electrochemical devices of claim 1, wherein the cathode comprises a layered structure, a spinel, a olivine with and without coating material including, but not limited to carbon, polymer, fluorine, metal oxides, NaFePO₄, NaCoO₂, NaNiO₂, NaMn₂O₄, or Na₁₋ₓNi_{α}Co_{β}Mn_{γ}M_{δ}O_{2-z}N_{z}, wherein M is Li, Al, Mg, Ti, B, Ga, Si, Zr, Zn, Cu, Fe; N is F, Cl, S; wherein 0≤x≤1, 0≤α≤1, 0≤β≤1, 0≤y≤1, 0≤6≤1, 0≤z≤2; with the proviso that at least one of α, β and γ is greater than 0.
